(19) United States
(12) Patent Application Publication
(10) Pub. No.: US 2021/0260904 A1
(43) Pub. Date: Aug. 26, 2021

(54) LIQUID DISCHARGE APPARATUS AND LIQUID DISCHARGE METHOD

(71) Applicant: Yuuma USUI, Tokyo (JP)

(72) Inventor: Yuuma USUI, Tokyo (JP)

(73) Assignee: Ricoh Company, Ltd., Ohta-ku, Tokyo (JP)

(21) Appl. No.: 17/256,278

(22) PCT Filed: Sep. 25, 2019
(86) PCT No.: PCT/JP2019/037527

§ 371 Date: Dec. 28, 2020

(30) Foreign Application Priority Data
Sep. 28, 2018 (JP) 2018-183491
Sep. 19, 2019 (JP) 2019-170548

(51) Int. Cl. B41M 5/00; B41J 3/407; B41J 11/00; B41M 7/00

(52) U.S. Cl. CPC B41M 5/0017; B41J 3/407; B41M 7/0081; B41M 5/0047; B41M 5/0064; B41J 11/00212

(57) ABSTRACT

A liquid discharge apparatus (1) includes a first liquid application device (10) configured to apply a first liquid containing an active energy ray curable liquid, onto a recording medium (19); a second liquid application device (12-15) configured to discharge, by an inkjet method, a plurality of second liquids each of which is an active energy ray curable liquid containing a colorant different from each other; an irradiation device (18) configured to irradiate, with an active energy ray, the first liquid and the plurality of second liquids. The liquid discharge apparatus (1) further includes a controller configured to control the first liquid application device (10), the second liquid application device (12-15), and the irradiation device (18). The controller causes the second liquid application device (12-15) to apply the plurality of second liquids onto the first liquid according to image data, to form a plane pattern group.

### TECHNICAL FIELD

The present disclosure relates to a liquid discharge apparatus and a liquid discharge method.

### BACKGROUND ART

In recent years, digital printing by an inkjet method has been performed on a recording medium other than paper, such as resin, metal, glass, wood, or a composite material thereof. In particular, when the recording medium is a floor material, a wall material, a packaging material, or the like, examples of a material of the recording medium include a resin film and resin-impregnated paper. For performing printing on these recording media, in addition to a solvent ink, an aqueous latex ink and an ultra violet (UV) ink are used from a viewpoint of volatile organic compound (VOC). Furthermore, an electron beam (EB) curable ink requiring a small amount of drying energy and not requiring an ink additive such a photo polymerization initiator is considered to be more preferable from viewpoints of quality and safety.

However, in a conventional inkjet printing apparatus for a resin film and resin-impregnated paper, securing of an ink droplet dot gain on a recording medium and suppression of unity/color mixture of adjacent ink droplets are not simultaneously achieved. Therefore, sufficient image quality is not obtained.

In addition, adhesion between a resin film and an image (ink) is weak, and there is also a problem in fastness, for example, an image is peeled off by rubbing or scratching.

Note that, for example, PTLs 1 and 2 disclose wet-on-wet image formation that imparts, by an inkjet method, a second liquid that is an active energy ray curable liquid containing a colorant onto a first liquid that is an active energy ray curable liquid.

### CITATION LIST

### Patent Literature

PTL 1: Japanese Unexamined Patent Application Publication No. 2011-230501

PTL 2: Japanese Patent No. 6197927 (Japanese Unexamined Patent Application Publication No. 2017-013506)

### SUMMARY OF INVENTION

### Technical Problem

An object of the present disclosure is to provide a liquid discharge apparatus capable of securing an ink droplet dot gain with a small amount of ink, suppressing unity/color mixture of adjacent ink droplets, and outputting a printed matter with high fastness with respect to a recording medium such as a resin film or resin-impregnated paper.

### Solution to Problem

An embodiment of the present disclosure provides a liquid discharge apparatus that includes a first liquid application device configured to apply a first liquid containing an active energy ray curable liquid, onto a recording medium; a second liquid application device configured to discharge, by an inkjet method, a plurality of second liquids each of which is an active energy ray curable liquid containing a colorant different from each other; an irradiation device configured to irradiate, with an active energy ray, the first liquid and the plurality of second liquids. The liquid discharge apparatus further includes a controller configured to control the first liquid application device, the second liquid application device, and the irradiation device. The controller causes the second liquid application device to apply the plurality of second liquids onto the first liquid according to image data, to form a plane pattern group.

Another embodiment provides liquid discharge method including applying a first liquid containing an active energy ray curable liquid onto a recording medium; applying, according to an image data, a plurality of second liquids onto the first liquid to form a plane pattern group on the recording medium; and irradiating the first liquid and the plurality of second liquids with an active energy ray. Each of the plurality of second liquids is an active energy ray curable liquid containing a colorant different from each other.

### Advantageous Effects of Invention

The present disclosure can provide a liquid discharge apparatus capable of securing an ink droplet dot gain with a small amount of ink, suppressing unity/color mixture of adjacent ink droplets, and outputting a printed matter with high fastness with respect to a recording medium such as a resin film or resin-impregnated paper.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a schematic view illustrating an example of a liquid discharge apparatus of the present disclosure.

FIG. 2 is a block diagram illustrating an example of a hardware configuration of the liquid discharge apparatus.

FIG. 3 is a diagram illustrating a configuration of a drive waveform generation circuit of the liquid discharge apparatus.

FIG. 4 is a block diagram illustrating an example of configurations of a head driver of the liquid discharge apparatus.

FIG. 5 is a view illustrating a plane pattern group of Example 1.

FIG. 6 is a view illustrating a plane pattern group of Example 2.

FIG. 7 is a view illustrating a plane pattern group of Example 3.

FIG. 8 is a view illustrating a plane pattern group of Example 4.

FIG. 9 is a view illustrating a plane pattern group of Example 5.

FIG. 10 is a view illustrating a plane pattern group of Example 6.

### DESCRIPTION OF EMBODIMENTS

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of the present disclosure will be further described.

A liquid discharge apparatus of the present disclosure includes: a device to apply a first liquid containing an active energy ray curable liquid onto a recording medium; an inkjet device to apply a second liquid containing an active energy ray curable liquid including a colorant onto the first liquid according to an image data; and an irradiation device for irradiating the first liquid and the second liquid with an active energy ray, and is characterized in that the second liquid contains a plurality of liquids containing different colorants, and the second liquid forms a plane pattern group on the recording medium. The liquid discharge apparatus of the present disclosure further includes another device as necessary.

A liquid discharge method of the present disclosure includes: a step of applying a first liquid containing an active energy ray curable liquid onto a recording medium; a step of applying a second liquid containing an active energy ray curable liquid including a colorant onto the first liquid according to an image data by an inkjet method; and a step of irradiating the first liquid and the second liquid with an active energy ray, and is characterized in that the second liquid contains a plurality of liquids containing different colorants, and the second liquid forms a plane pattern group on the recording medium. The liquid discharge method of the present disclosure further includes another step as necessary.

As described above, the apparatus and method of the present disclosure are based on a phenomena caused by inkjet method wet-on-wet image formation.

The second liquid is partially embedded in the first liquid, and unity of the second liquid (dots) due to wet spreading hardly occurs. Wet spreading occurs while avoiding unity. Therefore, a dot shape changes depending on where adjacent dots are disposed. These phenomena are largely different from an ink landing behavior on a solid surface.

Application of first liquid containing active energy ray curable liquid

The first liquid can be applied directly onto a recording medium.

The recording medium is not particularly limited, and can be appropriately selected according to a purpose. Examples of the recording medium include a resin film, resin-impregnated paper, synthetic paper made of synthetic fibers, natural paper, a sheet such as a nonwoven fabric, cloth, wood, and a metal sheet.

Examples of the resin film include a polyester film, a polypropylene film; a polyethylene film; a plastic film such as nylon, vinylon, or acrylic, and a film obtained by bonding the films. The resin film can be appropriately selected according to a purpose, but is preferably uniaxially or biaxially stretched in terms of strength.

The nonwoven fabric is not particularly limited, and can be appropriately selected according to a purpose. Examples of the nonwoven fabric include a product obtained by dispersing polyethylene fibers in a sheet form and subjecting the resulting sheet-like product to thermocompression bonding into a sheet form.

A method for applying the first liquid onto the recording medium is not particularly limited, and can be appropriately selected according to a purpose. Examples of the method include an application method such as a knife coating method, a nozzle coating method, a die coating method, a lip coating method, a comma coating method, a gravure coating method, a rotary screen coating method, a reverse roll coating method, a roll coating method, a spin coating method, a kneader coating method, a bar coating method, a blade coating method, a casting method, a dipping method, or a curtain coating method, and an inkjet method.

The coating film average thickness of the first liquid is not particularly limited and can be appropriately selected according to a purpose, but is preferably 10 to 50 micrometers.

First Liquid

The first liquid contains an active energy ray curable liquid. Examples of the active energy ray curable liquid include a liquid containing a monofunctional monomer having one functional group, a liquid containing a polyfunctional monomer having one or more functional groups, a liquid containing a polyfunctional oligomer, and a liquid containing a urethane acrylate oligomer, an epoxy acrylate oligomer, a polyester acrylate oligomer, or the like depending on the type of molecular structure, the monomer and the oligomer each having a functional group such as a vinyl group, an acryloyl group, or a methacryloyl group in a molecular structure thereof.

Examples of the monofunctional monomer include γ-butyrolactone (meth)acrylate, isobornyl (meth)acrylate, formalized trimethylolpropane mono (meth)acrylate, trimethylolpropane (meth)acrylic acid benzoate, (meth)acryloylmorpholine, 2-hydroxypropyl (meth)acrylamide, N-vinylcaprolactam, N-vinylpyrrolidone, N-vinylformamide, cyclohexanedimethanol monovinyl ether, hydroxyethyl vinyl ether, diethylene glycol monovinyl ether, dicyclopentadiene vinyl ether, tricyclodecane vinyl ether, benzyl vinyl ether, ethyl oxetane methyl vinyl ether, hydroxybutyl vinyl ether, ethyl vinyl ether, ethoxy (4) nonyl phenol (meth)acrylate, benzyl (meth)acrylate, and caprolactone (meth)acrylate. These compounds may be used singly or in combination of two or more types thereof.

Examples of the polyfunctional monomer include a polyfunctional acrylate and a polyfunctional methacrylate, such as ethylene glycol di(meth)acrylate, hydroxypivalic acid neopentyl glycol di(meth)acrylate, polytetramethylene glycol di(meth)acrylate, diethylene glycol di(meth)acrylate, triethylene glycol di(meth)acrylate, tetraethylene glycol di(meth)acrylate, polyethylene glycol dimethacrylate [CH2=CH—CO—(OC2H4)n-OCOCH═CH2 (n is almost equal to 9), CH2=CH—CO—(OC2H4)n-OCOCH═CH2 (n is almost equal to 14), CH2=CH—CO—(OC2H4)n-OCOCH═CH2 (n is almost equal to 23)], dipropylene glycol di(meth)acrylate, tripropylene glycol di(meth)acrylate, polypropylene glycol dimethacrylate [CH2=C(CH3)-CO—(OC3H6)n-OCOC(CH3)=CH2 (n is almost equal to 7)], 1,3-butanediol di(meth)acrylate, 1,4-butanediol di(meth)acrylate, 1,6-hexanediol di(meth)acrylate, 1,9-nonanediol di(meth)acrylate, neopentyl glycol di(meth)acrylate, tricyclodecane dimethanol di(meth)acrylate, propylene oxide modified bisphenol A di(meth)acrylate, polyethylene glycol di(meth)acrylate, dipentaerythritol hexa(meth)acrylate, propylene oxide modified tetramethylolmethane tetra(meth)acrylate, dipentaerythritol hydroxypenta(meth)acrylate, caprolactone modified dipentaerythritol hydroxypenta(meth)acrylate, ditrimethylolpropane tetra(meth)acrylate, pentaerythritol tetra(meth)acrylate, trimethylolpropane tri(meth)acrylate, ethylene oxide modified trimethyl propane tri(meth)acrylate, propylene oxide modified trimethylol propane tri(meth)acrylate, caprolactone modified trimethylol propane tri(meth)acrylate, pentaerythritol tri(meth)acrylate, tris(2-hydroxyethyl) isocyanurate tri(meth)acrylate, ethoxylated neopentyl glycol di(meth)acrylate, propylene oxide modified neopentyl glycol di(meth)acrylate, propylene oxide modified glyceryl tri(meth)acrylate, polyester di(meth)acrylate, polyester tri(meth)acrylate, polyester tetra(meth)acrylate, polyester penta(meth)acrylate, polyester poly(meth)acrylate, polyurethane di(meth)acrylate, polyurethane tri(meth)acrylate, polyurethane tetra(meth)acrylate, polyurethane penta(meth)acrylate, polyurethane poly(meth)acrylate, triethylene glycol divinyl ether, cyclohexane dimethanol divinyl ether, diethylene glycol divinyl ether, triethylene glycol divinyl ether, or ethoxylated (4) bisphenol di(meth)acrylate. These compounds may be used singly or in combination of two or more types thereof.

Among these compounds, the first liquid preferably contains at least one selected from a polyfunctional acrylate, a polyfunctional methacrylate, a urethane acrylate oligomer, an epoxy acrylate oligomer, and a polyester acrylate oligomer from a viewpoint of being able to obtain a printed matter with high fastness.

A mixed composition obtained by combining a monofunctional monomer and a polyfunctional monomer, or a mixed composition obtained by combining a monofunctional monomer and a polyfunctional oligomer may be used. However, the blending amount of the polyfunctional monomer and/or the polyfunctional oligomer is preferably 50% by mass or more with respect to the total amount of the first liquid from a viewpoint of fastness.

The first liquid may contain a polymerization initiator.

Any polymerization initiator may be used as long as being able to generate an active species such as a radical or a cation by energy of an active energy ray and to start polymerization of the first liquid. As such a polymerization initiator, a known radical polymerization initiator, a cationic polymerization initiator, a base generator, and the like can be used singly or in combination of two or more types thereof. Among these agents, a radical polymerization initiator is preferably used. The polymerization initiator is preferably contained in an amount of 1% by mass or more and 20% by mass or less with respect to the total amount of the first liquid in order to obtain a sufficient curing rate.

Examples of the radical polymerization initiator include an aromatic ketone, an acyl phosphine oxide compound, an aromatic onium salt compound, an organic peroxide, a thio compound (a thioxanthone compound, a thiophenyl group-containing compound, or the like), a hexaarylbiimidazole compound, a ketoxime ester compound, a borate compound, an azinium compound, a metallocene compound, an active ester compound, a compound having a carbon halogen bond, and an alkylamine compound.

In addition to the polymerization initiator, a polymerization accelerator (sensitizer) can also be used together.

The polymerization accelerator is not particularly limited and may be appropriately selected according to a purpose. Examples the polymerization accelerator include an amine compound such as trimethylamine, methyldimethanolamine, triethanolamine, pdiethylaminoacetophenone, ethyl p-dimethylaminobenzoate, 2-ethylhexyl p-dimethylaminobenzoate, N,N-dimethylbenzylamine, or 4,4′-bis(diethylamino) benzophenone. The content of the polymerization accelerator is not particularly limited, and may be appropriately set according to a polymerization initiator to be used and the amount thereof.

A surfactant may be added in order to lower surface tension to adjust wet spreading of the second liquid (ink).

Examples of the surfactant include a polyethylene glycol fatty acid ester, a glycerin fatty acid ester such as glyceryl monostearate, glyceryl monooleate, diglyceryl monostearate, or diglyceryl monoisostearate, a glycol fatty acid ester such as propylene glycol monostearate, a sorbitan fatty acid ester such as sorbitan monostearate or sorbitan monooleate, sucrose stearate, POE (4.2) lauryl ether, POE (40) hydrogenated castor oil, POE (10) cetyl ether, POE (9) lauryl ether, POE (10) oleyl ether, POE (20) sorbitan monooleate, POE (6) sorbit monolaurate, POE (15) cetyl ether, POE (20) sorbitan monopalmitate, POE (15) oleyl ether, POE (100) hydrogenated castor oil, POE (20) POP (4) cetyl ether, POE (20) cetyl ether, POE (20) oleyl ether, POE (20) stearyl ether, POE (50) oleyl ether, POE (25) cetyl ether, POE (25) lauryl ether, POE (30) cetyl ether, and POE (40) cetyl ether. These compounds may be used singly or in combination of two or more types thereof. The surfactant is preferably contained in an amount of 0.1% by mass or more and 2% by mass or less with respect to the total amount of the first active energy ray curable liquid.

The first liquid can further contain at least one selected from a white pigment, a metal powder pigment, a pearlescent pigment, and a fluorescent pigment from a viewpoint of being able to obtain a printed matter with high concealing performance and metallic gloss. Examples of the white pigment include titanium dioxide, aluminum oxide, calcium carbonate, magnesium carbonate, calcium sulfate, barium sulfate, silica sand, clay, talc, and silica.

The first liquid can also contain other components. The other components are not particularly limited, and can be appropriately selected according to a purpose. Examples of the other components include an organic solvent, a thickener, a dispersant, a deodorizing agent, an ultraviolet shielding agent, an antibacterial agent, and a antirust.

Preparation of First Liquid

The first liquid used in the present disclosure can be prepared using the various components described above, and preparation means and conditions thereof are not particularly limited, but examples thereof include a method for mixing the above materials using a dispersing machine such as a ball mill, a kitty mill, a disc mill, a pin mill, or a dyno mill.

The viscosity of the first liquid used in the present disclosure only needs to be appropriately adjusted according to a use and an application means, but is preferably high in order to apply the second liquid (ink) to the vicinity of a liquid surface of the first liquid. Meanwhile, the viscosity of the first liquid is preferably low in order to apply the first liquid to a recording medium uniformly, and is preferably 3,000 mPa×s or more and 50,000 mPa×s or less in a range of 20° C. to 65° C. Note that the viscosity can be measured by appropriately setting a shear rate to 10/s and a temperature in a range of 20° C. to 65° C., for example, with a rheometer MCR301 manufactured by Anton Paar using a cone plate CP25-1.

Surface tension can be measured by a plate method or a ring method, for example, with an automatic surface tension meter DY-300 manufactured by Kyowa Interface Science. The higher the surface tension of the first liquid is, more easily the second liquid causes wet spreading. In order to form a plane pattern group described below, the surface tension of the first liquid>the surface tension of the second liquid is preferably satisfied. Specifically, a difference in static surface tension at 25° C. is preferably more than 0 mN/m and 20 mN/m or less, and more preferably 2 mN/m or more and 10 mN/m or less. The static surface tension of the first liquid at 25° C. is preferably 25 mN/m or more and 45 mN/m or less.

Application of second liquid containing active energy ray curable liquid containing colorant

The second liquid is applied onto the first liquid according to an image data by an inkjet method.

The inkjet method can be a known method. For example, as a method for driving a discharge head, a piezoelectric element actuator using piezoelectric transducer (PZT), a method for applying thermal energy, an on-demand type head using an actuator utilizing electrostatic force can be used, and a continuous injection type charge control head can be used.

The second liquid contains a plurality of liquids containing different colorants, and contains three, four, or more types of liquids according to a colorant (pigment). Each of the liquids is discharged from an individual discharge head, and is applied onto the first liquid. A head nozzle density required for each color varies depending on a plane pattern group, and examples of the head nozzle density include 300 npi (nozzle per inch), 600 npi, and 1,200 npi.

The coating film average thickness of the second liquid is not particularly limited and can be appropriately selected according to a purpose, but is preferably 1 to 20 micrometers.

Second Liquid

The second liquid can have a similar composition to the first liquid. That is, the second liquid can contain the monomers, oligomers, polymerization initiators, polymerization accelerators, and the like described in the section of First liquid. However, the second liquid contains a colorant, for example, a pigment. Note that the viscosity of the second liquid is largely different from that of the first liquid. Specifically, the viscosity in a range of 20° C. to 65° C., desirably the viscosity at 40° C. is preferably 3 mPa×s or more and 40 mPa×s or less, more preferably 5 mPa×s or more and 15 mPa×s or less, and particularly preferably 6 mPa×s or more and 12 mPa×s or less. The static surface tension of the second liquid at 25° C. only needs to be appropriately determined to a surface tension suitable for discharging the second liquid from a nozzle of an inkjet head, and is preferably 15 to 45 mN/m, and particularly preferably 20 to 35 mN/m.

As the colorant, various pigments can be used which impart black, magenta, cyan, yellow, green, orange, purple, white, a glossy color such as gold or silver, and the like according to a purpose and required characteristics.

The content of the colorant only needs to be appropriately determined in consideration of a desired color density, dispersibility in a composition, and the like, and is not particularly limited, but is preferably 0.1% by mass or more and 20% by mass or less with respect to the total amount of the second liquid.

As the colorant, an inorganic pigment and an organic pigment can be used, and may be used singly or in combination of two or more types thereof.

Examples of the inorganic pigment include carbon black (C.I. pigment black 7) such as furnace black, lamp black, acetylene black, or channel black, iron oxide, and titanium oxide.

Examples of the organic pigment include an azo pigment such as an insoluble azo pigment, a condensed azo pigment, an azo lake, or a chelate azo pigment, a polycyclic pigment such as a phthalocyanine pigment, perylene and perinone pigments, an anthraquinone pigment, a quinacridone pigment, a dioxane pigment, a thioindigo pigment, an isoindolinone pigment, or a quinophthalone pigment, a dye chelate (for example, a basic dye type chelate or an acid dye type chelate), a dye lake (for example, a basic dye type lake or an acid dye type lake), a nitro pigment, a nitroso pigment, and aniline black.

In order to make the dispersibility of the pigment better, a dispersant may be further contained.

The dispersant is not particularly limited, and examples thereof include a dispersant commonly used for preparing a pigment dispersion, such as a polymer dispersant.

The other components are not particularly limited, and can be appropriately selected according to a purpose. Examples of the other components include an organic solvent, a surfactant, a polymerization inhibitor, a leveling agent, an defoamer, a fluorescence brightening agent, a permeation accelerator, a wetting agent (moisturizing agent), a fixing agent, a viscosity stabilizer, a antirust, a preservative, an antioxidant, and an ultraviolet absorber.

It is preferable not to contain the organic solvent if possible. A VOC-free composition not containing an organic solvent, particularly not containing a volatile organic solvent further enhances safety of a place where the composition is handled, and can prevent environmental pollution. Note that the term “organic solvent” means a general nonreactive organic solvent such as ether, ketone, xylene, ethyl acetate, cyclohexanone, or toluene, and should be distinguished from a reactive monomer. The phrase “not containing” an organic solvent means substantially not containing an organic solvent, and the content of the organic solvent is preferably less than 0.1% by mass.

Preparation of Second Liquid

The second liquid used in the present disclosure can be prepared using the various components described above, and preparation means thereof and conditions thereof are not particularly limited. However, for example, the second liquid can be prepared by putting a polymerizable monomer, a pigment, a dispersant, and the like in a dispersing machine such as a ball mill, a kitty mill, a disc mill, a pin mill, or a dyno mill and dispersing the polymerizable monomer, the pigment, the dispersant, and the like to prepare a pigment dispersion liquid, and further mixing a polymerizable monomer, an initiator, a polymerization inhibitor, a surfactant, and the like with the pigment dispersion liquid.

Preparation of Third Liquid

In the present disclosure, it is also possible to apply a third liquid containing an active energy ray curable liquid not containing a colorant onto the first liquid to which the second liquid has not been applied.

By applying such a third liquid to a non-image area (an area other than an image area containing an ink of the second liquid), a printed matter with high image quality without ink bleeding in the image area/non-image area can be obtained.

The third liquid can be applied onto the first liquid by an inkjet method similarly to the second liquid.

The third liquid can have a composition and a liquid physical property similar to the second liquid except that the third liquid does not contain a colorant.

The coating film average thickness of the third liquid is not particularly limited and can be appropriately selected according to a purpose, but is preferably 1 to 20 micrometers similarly to the second liquid.

Curing of First Liquid, Second Liquid, and Third Liquid

Curing of these liquids is performed by a curing device for performing curing by irradiation with an active energy ray. By the curing device, the first liquid, the second liquid, and the third liquid are simultaneously cured to obtain an integrated cured product.

The active energy ray only needs to be able to impart energy necessary for advancing a polymerization reaction of a polymerizable component in a liquid, such as an electron beam, an α ray, a β ray, a γ ray, or an X ray in addition to an ultraviolet ray, and is not particularly limited. In particular, when a high energy light source is used, a polymerization reaction can be advanced without using a polymerization initiator. In a case of irradiation with an ultraviolet ray, a mercury-free device is strongly desired from a viewpoint of environmental protection, and replacement with a GaN-based semiconductor ultraviolet ray emitting device is very useful industrially and environmentally. Furthermore, an ultraviolet ray emitting diodes (UV-light emitting diodes (LED)) and an ultraviolet ray laser diode (UV-LD) are small in size, long in life, high in efficiency, and low in cost, and are preferable as an ultraviolet ray light source. Curing conditions are not particularly limited, and can be appropriately selected according to a purpose. However, in a case of an ultraviolet ray, it is preferable to use an irradiation device that can emit an ultraviolet ray with an intensity of 6 W/cm or more at an irradiation distance of 2 mm. In a case of an electron beam, the electron beam preferably has such an accelerating voltage to achieve a dose of 15 kGy or more such that the entire coating film can be cured.

Other Steps and Other Devices

The liquid discharge apparatus of the present disclosure can further include an irradiation timing adjusting unit for adjusting timing of irradiation with an active energy ray by the active energy ray irradiation device. For example, the irradiation timing adjusting unit checks in advance a pattern formation rate by the second liquid on the first liquid, and adjusts time from the point of time of applying the second liquid onto the first liquid by an inkjet method to the point of time of curing the first liquid and the second liquid (also including the third liquid in some cases) by irradiation with an active energy ray. As a result, how the second liquid (also including the third liquid in some cases) causes wet spreading on the first liquid changes, and for example, it is possible to variably form an area where a colorant is not present between patterns.

The liquid discharge apparatus of the present disclosure can further include a heating device for heating the first liquid and/or the second liquid. By this heating, the first liquid and/or the second liquid become smooth, and a glossy printed matter can be obtained. The heating is performed before the first liquid and the second liquid (also including the third liquid in some cases) are irradiated with an active energy ray. Examples of the heating device include an infrared heater and a warm air heater. A heating temperature is preferably 40° C. or higher and 100° C. or lower in order to achieve the smoothing.

The other steps and other devices are not particularly limited, and can be appropriately selected according to a purpose. Examples of the other steps and other devices include an embossing step or device and a bending step or device.

The embossing step or devices is a step or device for forming an uneven pattern, and is performed by a known embossing device. Examples of the embossing device include an embossing device, a chemical embossing device, a rotary screen processing device, and a built-up printing device, usually using an emboss plate used for imparting unevenness to wallpaper, a decorative material, and the like.

In the present disclosure, the thickness of a second film formed of the second liquids is preferably thinner than the thickness of a first film formed of the first liquid. In some cases, the second film is a combination of the film formed of the second liquids and another film formed of the third liquid. According to this form, it is possible to embed the second liquid or the third liquid in the first liquid, and as a result, a printed matter with high fastness can be obtained. A difference between the thickness of the first film formed of the first liquid and the thickness of a second film formed of the second liquid is preferably 20 to 100 micrometers. Furthermore, in the present disclosure, the sum of the thickness of the first film formed of the first liquid and the thickness of the second film formed of the second liquid is preferably 30 micrometers or more. In some cases, the second film is a combination of the film formed of the second liquids and another film formed of the third liquid. According to this form, a printed matter with high image quality and fastness can be obtained.

The film thickness configuration as described above can be obtained by variously adjusting settings of, for example, the devices to apply the first liquid, the second liquids, the third liquid, and the active energy ray irradiation device 18. That is, a thickness adjusting unit 118 described later controls, at least one of, a first liquid application device (the application roller 10), a second liquid application device (the heads 12 to 15), a third liquid application device (the head 11), and the active energy ray irradiation device 18 (an irradiation device), to make the thickness of the second film as described above. The film thickness here is a film thickness after curing.

Here, the liquid discharge apparatus of the present disclosure will be described in detail with reference to the drawings.

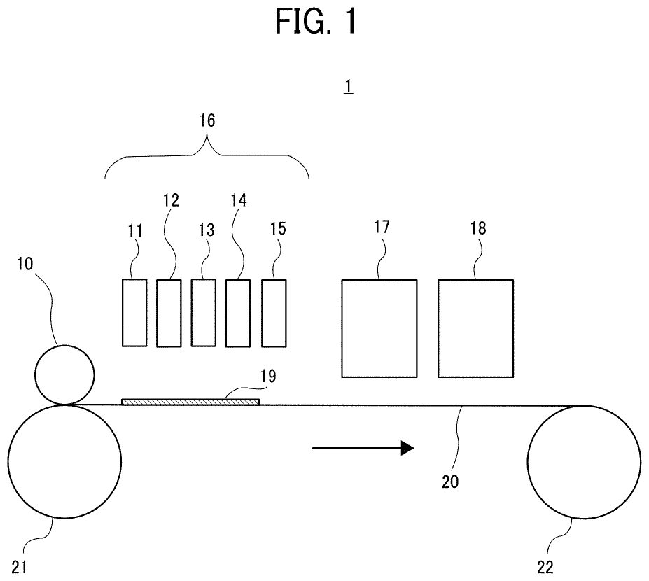

FIG. 1 is a schematic view illustrating an example of the liquid discharge apparatus of the present disclosure. A liquid discharge apparatus 1 in FIG. 1 includes an application roller 10 to apply a first liquid onto a base material (a recording medium) 19, a discharge head unit 16 disposed downstream from the application roller 10. The discharge head unit 16 includes a head 11 to apply a third liquid (clear ink) not containing a colorant by an inkjet method. Downstream therefrom, the discharge head unit 16 further includes a black head 12, a magenta head 13, a cyan head 14, and a yellow head 15 as heads to apply a plurality of second liquids by an inkjet method. The discharge head unit 16 further includes a heating device 17 and an active energy ray irradiation device 18. The liquid discharge apparatus 1 in FIG. 1 further includes a conveyance belt 20, a delivery roller 21 facing the application roller 10, and a winding roller 22. The conveyance belt 20 is wound by the winding roller 22, and the base material 19 is thereby conveyed in the direction indicated by an arrow in FIG. 1. The head 11 is an example of a third liquid application device.

First, the first liquid is applied to a surface of the base material 19 with the application roller 10.

Next, while conveying the base material 19 coated with the first liquid at a predetermined speed, the clear ink head 11 discharges, according to an inverted image pattern, a clear ink onto a non-image area on a coating film of the first liquid. Subsequently, the plurality of heads for the second liquids (the black head 12, the magenta head 13, the cyan head 14, and the yellow head 15) discharge, according to an image pattern, second liquids for black, magenta, cyan, and yellow onto an image area on the coating film of the first liquid.

Next, the heating device 17 heats the liquids to level the liquids. Thereafter, the first liquid, the second liquid, and the third liquid are irradiated with an active energy ray using the active energy ray irradiation device 18 under predetermined irradiation conditions, to solidify.

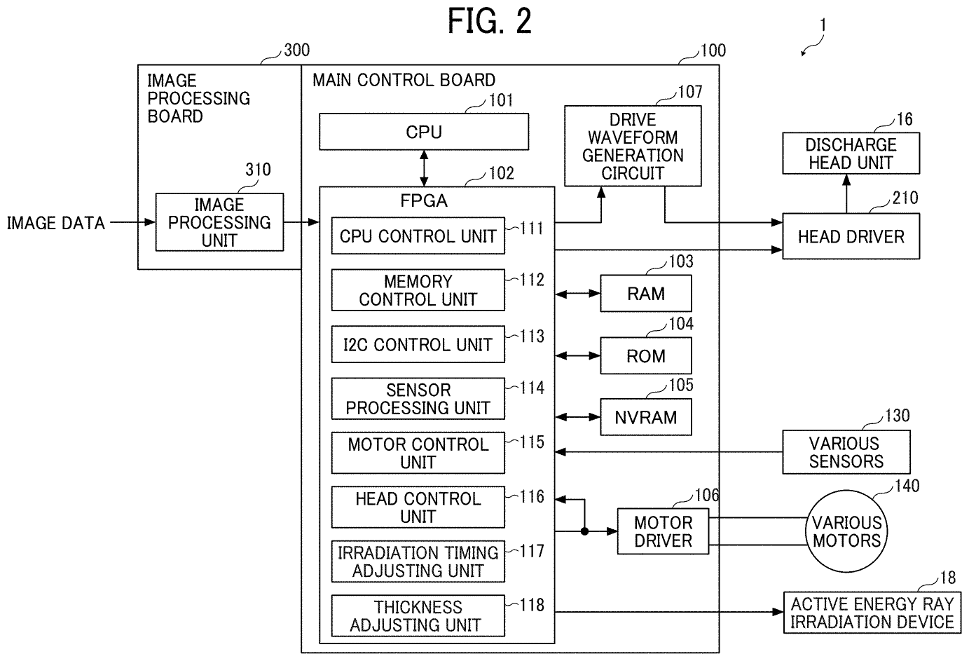

FIG. 2 is a block diagram illustrating an example of a hardware configuration of the liquid discharge apparatus 1 according to the present embodiment. The liquid discharge apparatus 1 includes a main control board 100 and an image processing board 30, which together construct a controller according to this disclosure.

On the main control board 100, a central processing unit (CPU) 101, a field-programmable gate array (FPGA) 102, a random access memory (RAM) 103, a read only memory (ROM) 104, a non-volatile random access memory (NVRAM) 105, a motor driver 106, a drive waveform generation circuit 107, and the like are mounted.

The CPU 101 controls the entire liquid discharge apparatus 1. For example, the CPU 101 uses the RAM 103 as a work area to execute various control programs stored on the ROM 104 in order to output a control command to control each operation in the liquid discharge apparatus 1. At this time, while communicating with the FPGA 102, the CPU 101 cooperates with the FPGA 102 to control various operations in the liquid discharge apparatus 1.

The FPGA 102 includes a CPU control unit 111, a memory control unit 112, an inter-integrated circuit (I2C) control unit 113, a sensor processing unit 114, a motor control unit 115, a head control unit 116, an irradiation timing adjusting unit 117, and the thickness adjusting unit 118.

The CPU control unit 111 has a capability to communicate with the CPU 101. The memory control unit 112 has a capability to access the RAM 103 and the ROM 104. The I2C control unit 113 has a capability to communicate with the NVRAM 105.

The sensor processing unit 114 processes sensor signals from various sensors 130. The term “various sensors 130” is a generic term representing sensors that detect various states in the liquid discharge apparatus 1. In addition to the encoder sensor, the various sensors 130 include a sheet sensor to detect the passage of the base material 19, a cover sensor to detect opening of a cover, a temperature and humidity sensor to detect ambient temperature and humidity, a sensor to detect the state of a lever to secure the base material 19, and an ink amount sensor to detect the amount of ink remaining in a cartridge. Note that an analog sensor signal output from the temperature and humidity sensor or the like is converted into a digital signal by an analog-to-digital (AD) converter mounted, for example, on the main control board 100 and input to the FPGA 102.

The discharge head unit 16 can be moved. In this case, a motor to drive the discharge head unit 16 to move is referred to as a main scanning motor. The movement direction in which the discharge head unit 16 is moved is referred to as a main scanning direction, and a direction orthogonal to the main scanning direction is referred to as a sub-scanning direction.

The motor control unit 115 controls various motors 140. The term “various motors 140” is a generic name representing the motors included in the liquid discharge apparatus 1. The various motors 140 include the main scanning motor, a sub-scanning motor to convey the base material 19 in the sub-scanning direction, a feeding motor to feed the base material 19, and a maintenance motor to drive a maintenance mechanism. The liquid discharge apparatus 1 can include the maintenance mechanism to maintain reliability of the heads. For example, the maintenance mechanism cleans the discharge face of the head, puts caps on the discharge face, and discharges unnecessary ink from the head.

Descriptions are given below of control of the main scanning motor, as an example control by cooperation between the CPU 101 and the motor control unit 115 of the FPGA 102. First, the CPU 101 sends, to the motor control unit 115, an instruction to start operation of the main scanning motor together with the travel speed and the travel distance of the discharge head unit 16. In response to a reception of such an instruction, the motor control unit 115 generates a drive profile, based on the travel speed and information on the operation start instruction notified from the CPU 101, calculates a pulse-width modulation (PWM) command value while performing comparing with an encoder value supplied from the sensor processing unit 114 (obtained from processing of the sensor signal from the encoder sensor), and outputs the PWM command value to the motor driver 106. Upon completion of the predetermined operation, the motor control unit 115 notifies the CPU 101 of the completion of the operation. Although the description above concerns the example in which the motor control unit 115 generates the drive profile, alternatively, the CPU 101 can be configured to generate the drive profile and transmit an instruction to the motor control unit 115. Further, the CPU 101 counts the number of printed sheets, the number of scanning of the head driven by the main scanning motor, and the like.

The head control unit 116 transmits head drive data stored in the ROM 104 to the drive waveform generation circuit 107, to cause the drive waveform generation circuit 107 to generate a common drive waveform signal Vcom. The common drive waveform signal Vcom generated by the drive waveform generation circuit 107 is input to a head driver 210 to be described later.

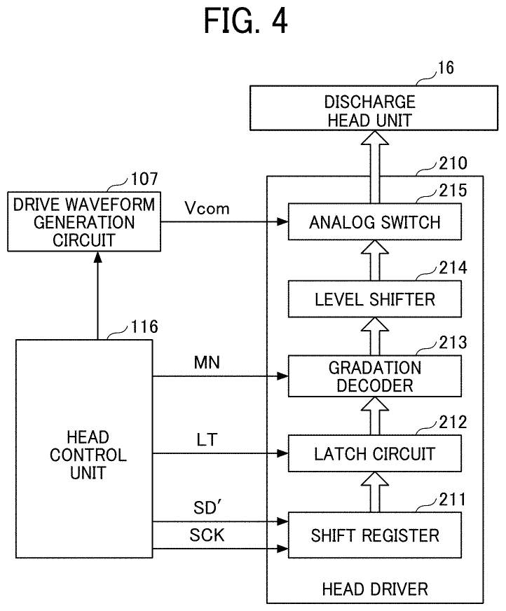

Further, the head control unit 116 receives the image data SD′ after the image processing from an image processing unit 310 mounted on the image processing board 300. Based on the image data SD′, the head control unit 116 generates a mask control signal MN. The mask control signal MN is for selecting a waveform of the common drive waveform signal Vcom according to the size of the ink droplet to be discharged from each nozzle of the discharge head unit 16 (i.e., the heads 12 to 15). Then, the head control unit 116 transmits image data SD, a synchronization clock signal SCK, a latch signal LT instructing latch of the image data, and the generated mask control signal MN to the head driver 210, as illustrated in FIG. 4.

As illustrated in FIG. 2, the image processing board 300 includes the image processing unit 310. The image processing unit 310 performs gradation processing for converting pixel values into density (luminance) for input image data. The image processing unit 310 performs rendering in which image data after gradation processing is converted (data is rearranged) into a format corresponding to the discharge head unit 16 (i.e., the heads 12 to 15). Thus, the image processing unit 310 generates the image data, that is, serial data (SD) to be supplied to the head control unit 116.

The irradiation timing adjusting unit 117 is also referred to as an active energy ray irradiation timing control unit, and adjusts the timing of irradiation of the active energy ray. As described above, for example, the irradiation timing adjusting unit 117 obtains, in advance, the speed of pattern formation with the second liquids on the first liquid and adjusts the time from the inkjet application of the second liquids on the first liquid to the irradiation of active energy ray thereto. The irradiation is for curing the first liquid and the second liquids (including the third liquid in some cases).

The thickness adjusting unit 118 adjusts the thickness of the film formed with the first liquid, the thickness of the film formed with the second liquids, and, in some cases, the thickness of the film formed with the third liquid. The manner of adjustment of film thickness can be changed suitably. For example, the film thickness is adjusted by changing the settings of the devices described above.

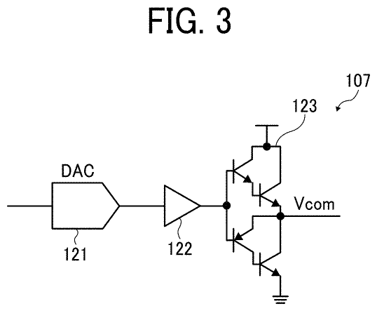

FIG. 3 is a diagram illustrating a configuration of the drive waveform generation circuit 107. As illustrated in FIG. 3, the drive waveform generation circuit 107 includes a digital to analog converter (DAC) 121, a voltage amplification unit 122, and a current amplification unit 123. The head drive data transferred from the head control unit 116 is subjected to analog conversion by the DAC 121 and voltage amplification by the voltage amplification unit 122. The voltage-amplified drive waveform is input, via the current amplification unit 123, to the head driver 210 as the common drive waveform signal Vcom. The current amplification unit 123 is constructed of a low impedance circuit including, for example, a SEEP circuit (an NPN transistor and a PNP transistor).

The head driver 210 drives the nozzles of the discharge head unit 16 (i.e., the heads 12 to 15) to discharge ink droplets, based on the common drive waveform signal Vcom input from the drive waveform generation circuit 107 and the image data SD′ transferred from the head control unit 116. Although the head driver 210 corresponds the discharge head unit 16 in FIG. 2, alternatively, the head driver 210 can be provided for each of the heads 11 to 15.

FIG. 4 is a block diagram illustrating an example of the configuration of the head driver 210. As illustrated in FIG. 4, the head driver 210 includes a shift register 211, a latch circuit 212, a gradation decoder 213, a level shifter 214, and an analog switch 215.

The shift register 211 receives the image data SD′ and the synchronization clock signal SCK transmitted from the head control unit 116. The latch circuit 212 latches each value on the shift register 211 according to the latch signal LT transmitted from the head control unit 116.

The gradation decoder 213 decodes the value (the image data SD′) latched by the latch circuit 212 and the mask control signal MN and outputs the result. The level shifter 214 converts the level of a logic level voltage signal of the gradation decoder 213 to a level at which the analog switch 215 can operate.

The analog switch 215 is turned on and off by the output received from the gradation decoder 213 via the level shifter 214. The analog switch 215 is provided for each nozzle of the heads 11 to 15 and is coupled to an individual electrode of a piezoelectric element corresponding to each nozzle. In addition, the common drive waveform signal Vcom from the drive waveform generation circuit 107 is input to the analog switch 215. Therefore, the analog switch 215 is switched between on and off in accordance with the output from the gradation decoder 213 via the level shifter 214. With this operation, the waveform to be applied to the piezoelectric element corresponding to each nozzle is selected from the drive waveforms forming the common drive waveform signal Vcom. As a result, the size of the ink droplet discharged from the nozzle is controlled.

Although the description above concerns the discharge head employing a piezoelectric element, the discharge head is not limited thereto. For example, a thermal inkjet head including a heater to heat the liquid, thereby discharging the liquid, can be used.

### EXAMPLES

Hereinafter, the present disclosure will be further described with reference to Examples and Comparative Examples, but the present disclosure is not limited to the following examples.

### Example 1

The liquid discharge apparatus 1 illustrated in FIG. 1 was used.

As the discharge head unit 16, three GEN5 heads (MH5420, 150 npi×4 rows, two-color compatible model) manufactured by Ricoh Printing Systems, Inc., consisting of one GEN5 head (that can correspond to 600 dpi dot density) as the clear ink head 11, one GEN5 head (that can correspond to 300 dpi dot density for black and magenta) as the black head 12 and the magenta head 13, and one GEN5 head (that can correspond to 300 dpi dot density for cyan and yellow) as the cyan head 14 and the yellow head 15, were disposed sequentially in a base material conveyance direction. At this time, adjustment was performed by a position adjustment mechanism of the discharge head unit 16 such that the nozzle numbers of the respective GEN5 heads did not deviate by 10 micrometers or more in the base material conveyance direction. The discharge head unit 16 was heated to 40° C., and a discharge drive waveform was adjusted such that drawing could be performed with a droplet size of 7 pL. Each color ink as the second liquid was discharged at a discharge frequency of 300 dpi in the base material conveyance direction, and a clear ink as the third liquid was discharged at a discharge frequency of 600 dpi.

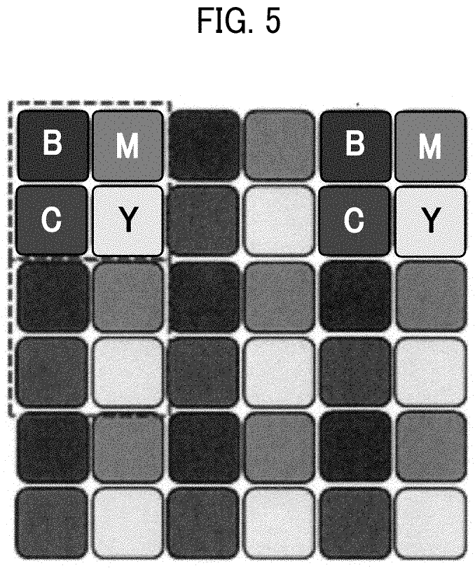

FIG. 5 is a view illustrating a plane pattern group of Example 1. This plane pattern group is a collection of quadrangular dots (square in the form of FIG. 5), and a constituent unit of the collection includes a pattern of 2×2 dots formed by a plurality of the second liquids containing four different colorants.

The heating device 17 was obtained by combining a Lutex blower G series manufactured by Hitachi Sanki Systems Co., Ltd., a high temperature hot air generation electric heater XS-2 manufactured by Kansai Electric Heat Corp., and a high blow nozzle 50AL manufactured by Kansai Electric Heat Corp. and adjusting the combined heating device so as to have a wind speed of 2 m/sec from a tip of a nozzle. The active energy ray irradiation device 18 was a linear irradiation type UV-LED light source GJ-75 manufactured by Hamamatsu Photonics K.K., and the base material was irradiated with light from a distance of 10 mm.

A PET film (Lumirror #350, film thickness 342 micrometers) manufactured by Toray Industries, Inc. was used as the base material 19. First, the following first liquid A was applied to a surface of the base material with an application roller 10 so as to have an average thickness of 25 micrometers.

Next, this base material was conveyed at a speed of 15 m/min, and a third liquid (clear ink) A0 not containing the colorant described below was discharged from the clear head 11 to a non-image area in a 7 pL droplet. The coating film of the third liquid A0 had a thickness of 8 micrometers. Subsequently, from the black head 12, the magenta head 13, the cyan head 14, and the yellow head 15, second liquids (color inks) A1 to A4 for black (B), magenta (M), cyan (C), and yellow (Y) described below were discharged in a 7 pL droplet, respectively. The coating film of the second liquid had a thickness of 8 micrometers.

Next, the first liquid, the second liquid, and the third liquid were subjected to heating leveling by the heating device 17, and cured by the active energy ray irradiation device 18.

As a result, a printed matter of Example 1 was obtained.

Preparation of First Liquid

By stirring 94.9 parts by mass of 2-acryloyloxypropyl phthalic acid (manufactured by Shin-Nakamura Chemical Co., Ltd.), 5 parts by mass of Omnirad TPO (manufactured by IGM Resins) as an initiator, and 0.1 parts by mass of BYK-UV-3510 (manufactured by BYK) as a surfactant, the first liquid A was prepared.

The first liquid A had a static surface tension of 26 mN/m at 25° C., and a viscosity of 16,000 mPa×s at 25° C.

Preparation of Clear Ink

By stirring 25 parts by mass of phenoxyethyl acrylate (manufactured by Tokyo Chemical Industry Co., Ltd.), 26 parts by mass of acryloyl morpholine (manufactured by Tokyo Chemical Industry Co., Ltd.), 42 parts by mass of trimethylolpropane ethoxy triacrylate (manufactured by Daicel Ornex Co., Ltd.), 5 parts by mass of Omnirad TPO (manufactured by IGM Resins) as an initiator, and 2 parts by mass of Solsperse 32000 (manufactured by Lubrizol) as a surfactant/dispersant, a clear ink A0 was prepared.

The above liquid had a static surface tension of 24 mN/m at 25° C., and a viscosity of 8 mPa×s at 40° C.

Preparation of Black Ink

By stirring 25 parts by mass of phenoxyethyl acrylate (manufactured by Tokyo Chemical Industry Co., Ltd.), 26 parts by mass of acryloyl morpholine (manufactured by Tokyo Chemical Industry Co., Ltd.), 35 parts by mass of trimethylolpropane ethoxy triacrylate (manufactured by Daicel Ornex Co., Ltd.), 5 parts by mass of Omnirad TPO (manufactured by IGM Resins) as an initiator, 2 parts by mass of Solsperse 32000 (manufactured by Lubrizol) as a surfactant/dispersant, and 7 parts by mass of SPECIAL BLACK 350 (black pigment manufactured by BASF Japan Ltd.) as a colorant, a black ink A1 was prepared.

The above liquid had a static surface tension of 24 mN/m at 25° C., and a viscosity of 10 mPa×s at 40° C.

Preparation of Magenta Ink

By stirring 25 parts by mass of phenoxyethyl acrylate (manufactured by Tokyo Chemical Industry Co., Ltd.), 26 parts by mass of acryloyl morpholine (manufactured by Tokyo Chemical Industry Co., Ltd.), 35 parts by mass of trimethylolpropane ethoxy triacrylate (manufactured by Daicel Ornex Co., Ltd.), 5 parts by mass of Omnirad TPO (manufactured by IGM Resins) as an initiator, 2 parts by mass of Solsperse 32000 (manufactured by Lubrizol) as a surfactant/dispersant, and 7 parts by mass of CINQUASIA MAGENTA RT-355-D (magenta pigment manufactured by BASF Japan Ltd.) as a colorant, a magenta ink A2 was prepared.

The above liquid had a static surface tension of 24 mN/m at 25° C., and a viscosity of 10 mPa×s at 40° C.

Preparation of Cyan Ink

By stirring 25 parts by mass of phenoxyethyl acrylate (manufactured by Tokyo Chemical Industry Co., Ltd.), 26 parts by mass of acryloyl morpholine (manufactured by Tokyo Chemical Industry Co., Ltd.), 35 parts by mass of trimethylolpropane ethoxy triacrylate (manufactured by Daicel Ornex Co., Ltd.), 5 parts by mass of Omnirad TPO (manufactured by IGM Resins) as an initiator, 2 parts by mass of Solsperse 32000 (manufactured by Lubrizol) as a surfactant/dispersant, and 40 parts by mass of IRGALITE BLUE GLVO (cyan pigment manufactured by BASF Japan Ltd.) as a colorant, a cyan ink A3 was prepared.

The above liquid had a static surface tension of 24 mN/m at 25° C., and a viscosity of 10 mPa×s at 40° C.

Preparation of Yellow Ink

By stirring 25 parts by mass of phenoxyethyl acrylate (manufactured by Tokyo Chemical Industry Co., Ltd.), 26 parts by mass of acryloyl morpholine (manufactured by Tokyo Chemical Industry Co., Ltd.), 35 parts by mass of trimethylolpropane ethoxy triacrylate (manufactured by Daicel Ornex Co., Ltd.), 5 parts by mass of Omnirad TPO (manufactured by IGM Resins) as an initiator, 2 parts by mass of Solsperse 32000 (manufactured by Lubrizol) as a surfactant/dispersant, and 40 parts by mass of NOVOPERM YELLOW H2G (yellow pigment manufactured by Clamant) as a colorant, a yellow ink A4 was prepared.

The above liquid had a static surface tension of 24 mN/m at 25° C., and a viscosity of 10 mPa×s at 40° C.

### Example 2

As the discharge head unit 16, five GEN4 heads (MH2420, 150 npi×two rows) manufactured by Ricoh Printing Systems, Inc., consisting of GEN4 heads as the clear ink head 11, the black head 12, the magenta head 13, the cyan head 14, and the yellow head 15 (each of which can correspond to 300 dpi dot density), were disposed such that the nozzle numbers of the respective GEN4 heads did not deviate by 10 micrometers or more in a base material conveyance direction.

Each color ink as the second liquid was discharged at a discharge frequency of 300 dpi in the base material conveyance direction, and a clear ink as the third liquid was discharged at a discharge frequency of 1,200 dpi.

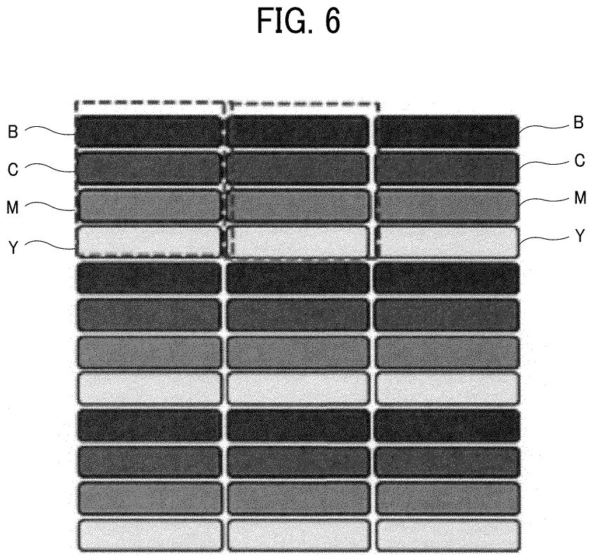

FIG. 6 is a view illustrating a plane pattern group of Example 2. This plane pattern group is a collection of quadrangular dots (rectangle in the form of FIG. 6), and a constituent unit of the collection includes a pattern of 1×4 dots formed by a plurality of the second liquids (four second liquids) containing four different colorants.

A printed matter of Example 2 was obtained in a similar manner to Example 1 except for the above.

### Example 3

The discharge head unit 16 was similar to that in Example 1. However, black+magenta GEN5 head nozzles and cyan+yellow GEN5 head nozzles were disposed so as to be a staggered arrangement.

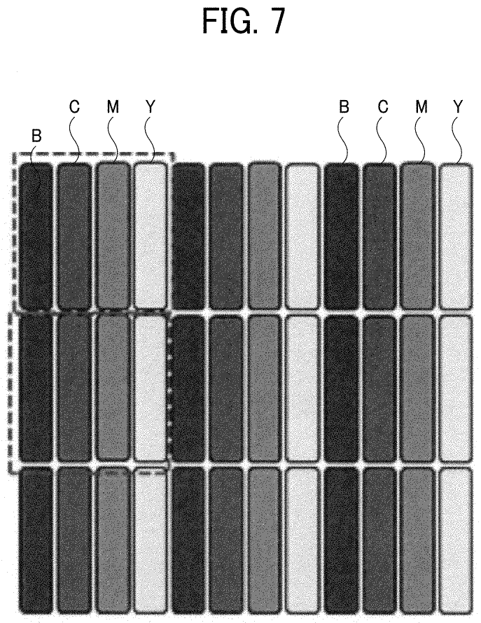

FIG. 7 is a view illustrating a plane pattern group of Example 3. This plane pattern group is a collection of quadrangular dots (rectangle in the form of FIG. 7), and a constituent unit of the collection includes a pattern of 1×4 dots formed by a plurality of the second liquids (four second liquids) containing four different colorants.

A printed matter of Example 3 was obtained in a similar manner to Example 1 except for the above.

### Example 4

The discharge head unit 16 was similar to that in Example 3. However, discharge was performed by shifting the discharge timings of a black ink, a cyan ink, a magenta ink, and a yellow ink by 1,200 dpi from one another.

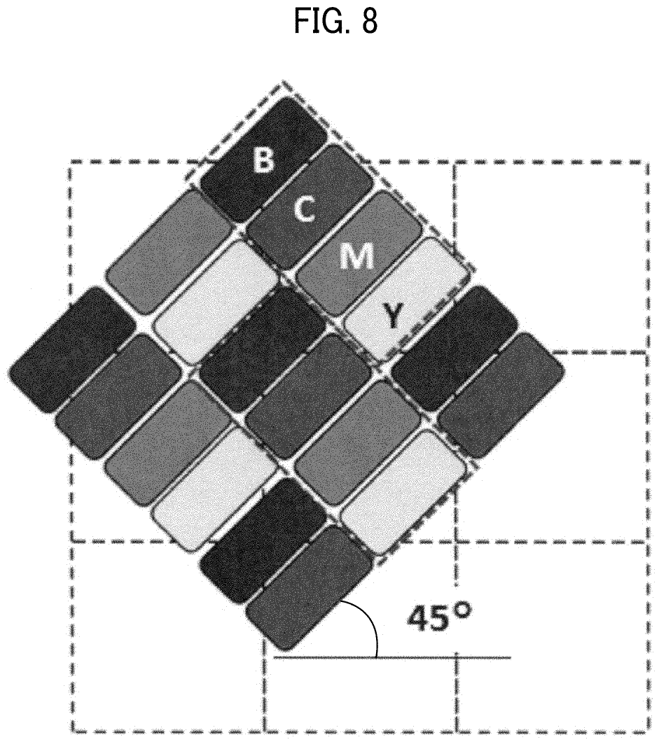

FIG. 8 is a view illustrating a plane pattern group of Example 4. This plane pattern group is a collection of quadrangular dots (rectangle in the form of FIG. 8), and a constituent unit of the collection includes a pattern of 1×4 dots formed by a plurality of the second liquids (four second liquids) containing four different colorants, and the pattern is at an angle of 45 degrees to a feed direction of an inkjet head.

A printed matter of Example 4 was obtained in a similar manner to Example 1 except for the above.

### Example 5

The discharge head unit 16 was similar to that in Example 1. However, discharge was performed by shifting the discharge timing of a magenta ink by 300×2√3 dpi from the discharge timing of a black ink. Discharge was performed at a discharge frequency of 300×√3/2 dpi in a base material conveyance direction.

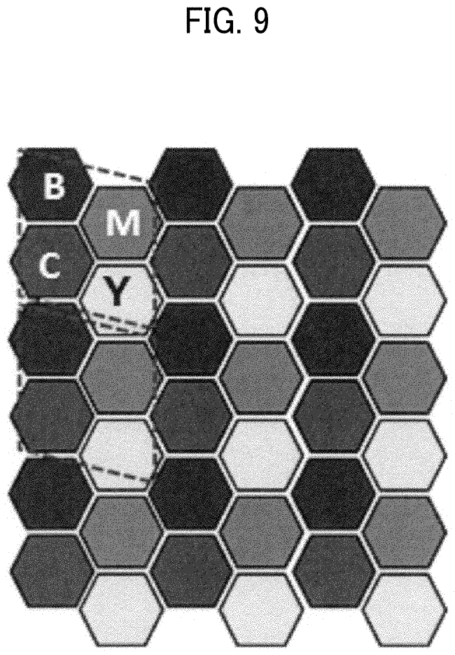

FIG. 9 is a view illustrating a plane pattern group of Example 5. This plane pattern group is a collection of hexagonal dots (regular hexagon in the form of FIG. 9), and a constituent unit of the collection includes a pattern of 2×2 dots formed by a plurality of the second liquids (four second liquids) containing four different colorants.

A printed matter of Example 5 was obtained in a similar manner to Example 1 except for the above.

### Example 6

As the discharge head unit 16, six GEN4 heads consisting of three clear ink heads 11, one magenta head 13, one cyan head 14, and one yellow head 15 were used. Discharge was performed by shifting the discharge timing of a yellow ink by 900×√3 dpi from the discharge timings of a magenta ink and a cyan ink. Discharge was performed at a discharge frequency of 900×√3/2 dpi (discharge was not performed once in three times) in a base material conveyance direction.

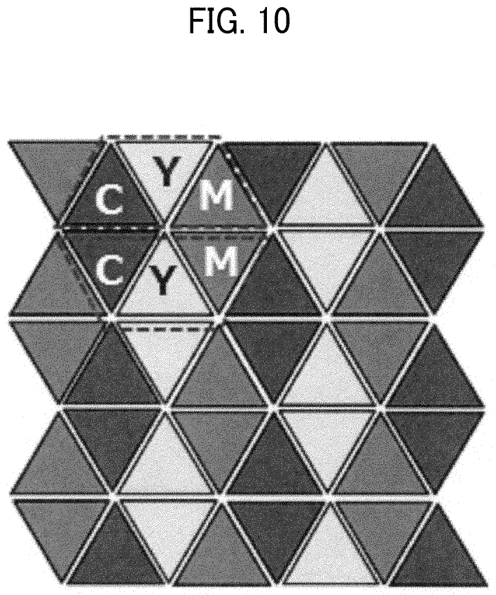

FIG. 10 is a view illustrating a plane pattern group of Example 6. This plane pattern group is a collection of triangular dots (equilateral triangle in the form of FIG. 10), and a constituent unit of the collection includes a pattern of 1×3 dots formed by a plurality of the second liquids (four second liquids) containing four different colorants.

A printed matter of Example 6 was obtained in a similar manner to Example 1 except for the above.

### Example 7

As the active energy ray irradiation device 18, an electron beam irradiation device EC300/30/30 mA manufactured by Iwasaki Electric Co., Ltd. was used. As for the inside of an inert gas blanket, a N2 gas generator with a compressor (Maxi-Flow 30 manufactured by Inhouse Gas, Inc.) was connected at a pressure of 0.2 MPa, N2 was caused to flow at a flow rate of 2 L/min to 10 L/min, and an oxygen concentration was set to 500 ppm or less. Irradiation was performed with an electron beam under irradiation conditions that an accelerating voltage was 30 kV and a dose was 30 kGy, and curing was performed.

A printed matter of Example 7 was obtained in a similar manner to Example 1 except for this.

### Example 8

In Example 1, drawing was performed using the color inks A1 to A4 without using the clear ink A0 to obtain a printed matter of Example 8.

### Example 9

In Example 2, drawing was performed using the color inks A1 to A4 without using the clear ink A0 to obtain a printed matter of Example 9.

### Example 10

In Example 3, drawing was performed using the color inks A1 to A4 without using the clear ink A0 to obtain a printed matter of Example 10.

### Example 11

In Example 4, drawing was performed using the color inks A1 to A4 without using the clear ink A0 to obtain a printed matter of Example 11.

### Example 12

In Example 5, drawing was performed using the color inks A1 to A4 without using the clear ink A0 to obtain a printed matter of Example 12.

### Example 13

In Example 6, drawing was performed using the color inks A1 to A4 without using the clear ink A0 to obtain a printed matter of Example 13.

### Example 14

In Example 7, drawing was performed using the color inks A1 to A4 without using the clear ink A0 to obtain a printed matter of Example 14.

### Example 15

A printed matter of Example 15 was obtained in a similar manner to Example 1 except that the first liquid A was replaced with the following first liquid B in Example 1.

Preparation of First Liquid

By stirring 95 parts by mass of 2-acryloyloxypropyl phthalic acid (manufactured by Shin-Nakamura Chemical Co., Ltd.) and 5 parts by mass of Omnirad TPO (manufactured by IGM Resins) as an initiator, the first liquid B was prepared (excluding the surfactant from the first liquid A).

The above liquid had a static surface tension of 39 mN/m at 25° C., and a viscosity of 16,000 mPa×s at 25° C.

### Comparative Example 1

By applying a color ink directly to a base material without using the first liquid A In Example 1, a printed matter of Comparative Example 1 was obtained.

Image quality (image quality and fastness) was evaluated as follows for each of the obtained printed matters of Examples 1 to 15 and Comparative Example 1, and results thereof are illustrated in Table 1.

Method for Evaluating Image Quality of Printed Matter

A solid image of 10 mm square was formed with process black (composite black) by superimposed four colors, and bleeding of an image area/non-image area was judged from the size of the solid image of an actual printed matter according to the following criteria.

Criteria for Judgment-Bleeding of Image Area/Non-Image Area—

Good: The average length of one side of a solid image is less than 10.5 mm

Fair: The average length of one side of a solid image is 10.5 to 11 mm

Poor: The average length of one side of a solid image is 11 mm or more

The coloring density of a solid image was visually judged according to the following criteria.

Criteria for Judgment-Coloring Density—

Good: Level at which the coloring density of a solid image is sufficient

Fair: Level at which the coloring density of a solid image is slightly insufficient

Poor: Level at which the coloring density of a solid image is insufficient

Coloring density unevenness (coloring density uniformity) of a solid image was visually judged according to the following criteria.

Criteria for Judgment-Coloring Density Unevenness—

Good: A pattern due to coloring density unevenness is not recognizable on a surface of a solid image

Fair: A pattern due to coloring density unevenness can be confirmed on a surface of a solid image, but is not noticeable

Poor: A noticeable pattern due to coloring density unevenness can be confirmed on a surface of a solid image

By rubbing a printed matter with a nonwoven fabric 100 times and scratching the printed matter with a nail, fixability of a solid image to a base material was judged according to the following criteria.

Criteria for Judgment-Fixability—

Good: Damage on a printed surface due to rubbing is not recognizable, and peeling from a base material is not recognizable

Fair: Damage on a printed surface due to rubbing is slightly observed, and peeling from a base material is not recognizable

Poor: Damage on a printed surface due to rubbing is observed, or peeling from a base material can be confirmed

By spraying water/ethanol onto a printed matter and allowing the printed matter to stand for 12 hours, water resistance/alcohol resistance was judged according to the following criteria.

Criteria for Judgment-Water Resistance/Alcohol Resistance—

Good: A decrease in coloring density due to liquid contact is not observed, and peeling from a base material is not observed

Fair: A decrease in coloring density due to liquid contact is observed slightly, and peeling from a base material is not observed

Poor: A decrease in coloring density due to liquid contact is observed, or peeling from a base material can be confirmed

TABLE 11

| | Bleeding | | | | |
|---|---|---|---|---|---|
| | of image | | | | Water |
| | area/non- | | Coloring | | resistance/ |
| | image | Coloring | density | | alcohol |
| | area | density | unevenness | Fixability | resistance |
| Example 1 | Good | Good | Good | Good | Good |
| Example 2 | Good | Good | Good | Good | Good |
| Example 3 | Good | Good | Good | Good | Good |
| Example 4 | Good | Good | Good | Good | Good |
| Example 5 | Good | Good | Good | Good | Good |
| Example 6 | Good | Good | Good | Good | Good |
| Example 7 | Good | Good | Good | Good | Good |
| Example 8 | Fair | Good | Good | Good | Good |
| Example 9 | Fair | Good | Good | Good | Good |
| Example 10 | Fair | Good | Good | Good | Good |
| Example 11 | Fair | Good | Good | Good | Good |
| Example 12 | Fair | Good | Good | Good | Good |
| Example 13 | Fair | Good | Good | Good | Good |
| Example 14 | Fair | Good | Good | Good | Good |
| Example 15 | Good | Good | Good | Good | Good |
| Comparative | Good | Poor | Poor | Poor | Fair |
| Example 1 | | | | | |

From the results of Table 1, it has been found that the printed matters of Examples 1 to 15 have better image quality (image quality/fastness) than the printed matter of Comparative Example 1.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The processing apparatuses can include any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium (carrier means). The carrier medium can include a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

This patent application is based on and claims priority pursuant to 35 U.S.C. § 119(a) to Japanese Patent Application Nos. 2018-183491, filed on Sep. 28, 2018, and 2019-170548, filed on Sep. 19, 2019, in the Japan Patent Office, the entire disclosure of which is hereby incorporated by reference herein.

### REFERENCE SIGNS LIST

1 Liquid Discharge Apparatus
10 Application Roller
11 Clear Ink Head
12 Black Head
13 Cyan Head
14 Magenta Head
15 Yellow Head
16 Discharge Head Unit
17 Heating Device
18 Active Energy Ray Irradiation Device
19 Base Material
20 Conveyance Belt
21 Delivery Roller
22 Winding Roller

1. A liquid discharge apparatus, comprising:
a first liquid application device configured to apply a first liquid containing an active energy ray curable liquid, onto a recording medium;
a second liquid application device configured to discharge, by an inkjet method, a plurality of second liquids, each of the plurality of second liquids being an active energy ray curable liquid containing a colorant different from another of the plurality of second liquids;
an irradiation device configured to irradiate, with an active energy ray, the first liquid and the plurality of second liquids; and
a controller configured to:
control the first liquid application device, the second liquid application device, and the irradiation device; and
cause the second liquid application device to apply the plurality of second liquids onto the first liquid according to image data, to form a plane pattern group.

2. The liquid discharge apparatus according to claim 1,
wherein the plurality of second liquids includes four second liquids,
wherein the plane pattern group is a collection of quadrangular dots, and
wherein a unit of the plane pattern group is a pattern of 2×2 dots formed by the four second liquids.

3. The liquid discharge apparatus according to claim 1,
wherein the plurality of second liquids includes four second liquids,
wherein the plane pattern group is a collection of quadrangular dots, and
wherein a unit of the plane pattern group is a pattern of 1×4 dots formed by the four second liquids.

4. The liquid discharge apparatus according to claim 1,
wherein the plurality of second liquids includes four second liquids,
wherein the plane pattern group is a collection of quadrangular dots,
wherein a unit of the plane pattern group is a pattern of 1×4 dots formed by the four second liquids, and
wherein the pattern is at an angle of 45 degrees to a movement direction of the second liquid application device.

5. The liquid discharge apparatus according to claim 1,
wherein the plurality of second liquids includes four second liquids,
wherein the plane pattern group is a collection of hexagonal dots, and
wherein a unit of the plane pattern group is a pattern of 2×2 dots formed by the four second liquids.

6. The liquid discharge apparatus according to claim 1,
wherein the plurality of second liquids includes four second liquids,
wherein the plane pattern group is a collection of triangular dots, and
wherein a unit of the plane pattern group is a pattern of 1×3 dots formed by the four second liquids.

7. The liquid discharge apparatus according to claim 1, wherein the controller includes a timing adjustor configured to adjust a tinning of irradiation with the active energy ray by the irradiation device.

8. The liquid discharge apparatus according to claim 1, further comprising:
a third liquid application device configured to discharge a third liquid containing an active energy ray curable liquid not containing a colorant,
wherein the controller is configured to cause the third liquid application device to apply the third liquid onto the first liquid according to image data.

9. The liquid discharge according to claim 1, further comprising a heater configured to heat at least one of the first liquid and the plurality of second liquids.

10. The liquid discharge apparatus according to claim 1, wherein the first liquid contains at least one of a polyfunctional acrylate, a polyfunctional methacrylate, a urethane acrylate oligomer, an epoxy acrylate oligomer, and a polyester acrylate oligomer.

11. The liquid discharge apparatus according to claim 1, wherein the first liquid contains at least one of a white pigment, a metal powder pigment, a pearlescent pigment, and a fluorescent pigment.

12. The liquid discharge apparatus according to claim 1, wherein the controller includes a thickness adjustor configured to control at least one of the first liquid application device, the second liquid application device, and the irradiation device, to make a thickness of a second film formed of the plurality of second liquids relatively thinner than a thickness of a first film formed of the first liquid.

13. The liquid discharge apparatus according to claim 1, wherein the controller includes a thickness adjustor configured to control at least one of the first liquid application device, the second liquid application device, and the irradiation device, to set a sum of a thickness of a first film formed of the first liquid and a thickness of a second film formed of the plurality of second liquids, to 30 micrometers or greater.

14. The liquid discharge apparatus according to claim 8, wherein the controller includes a thickness adjustor configured to control at least one of the first liquid application device, the second liquid application device, the third liquid application device, and the irradiation device, to make a thickness of a second film formed of the plurality of second liquids and the third liquid relatively thinner than a thickness of a first film formed of the first liquid.

15. The liquid discharge apparatus according to claim 8, wherein the controller includes a thickness adjustor configured to control at least one of the first liquid application device, the second liquid application device, the third liquid application device, and the irradiation device, to set a sum of a thickness of a first film formed of the first liquid and a thickness of a second film formed of the plurality of second liquids and the third liquid, to 30 micrometers or greater.

16. A liquid discharge method, comprising:
applying a first liquid containing an active energy ray curable liquid onto a recording medium;
applying, according to an image data, a plurality of second liquids onto the first liquid to form a plane pattern group on the recording medium, each of the plurality of second liquids being an active energy ray curable liquid containing a colorant different from another of the plurality of second liquids; and
irradiating the first liquid and the plurality of second liquids with an active energy ray.

17. The liquid discharge method according to claim 16, further comprising:
applying a third liquid, containing an active energy ray curable liquid not containing a colorant, onto the first liquid according to the image data.

18. The liquid discharge method according to claim 16, further comprising:
heating at least one of the first liquid and the plurality of second liquids.

19. The liquid discharge according to claim 8, further comprising a heater configured to heat at least one of the first liquid and the plurality of second liquids.

20. The liquid discharge apparatus according to claim 14, wherein the controller includes a thickness adjustor configured to control at least one of the first liquid application device, the second liquid application device, the third liquid application device, and the irradiation device, to set a sum of a thickness of a first film formed of the first liquid and a thickness of a second film formed of the plurality of second liquids and the third liquid, to 30 micrometers or greater.
